(19) United States
(12) Patent Application Publication
(10) Pub. No.: US 2022/0237466 A1
(43) Pub. Date: Jul. 28, 2022

(54) INTERLOCKING BACKPROBAGATION FOR AUTOMATED TRAINING OF COMPUTER PREDICTIVE MODELS

(71) Applicant: Cohere Inc., Toronto (CA)

(72) Inventors: Aidan Gomez, Toronto (CA); Nicholas Frosst, Toronto (CA); Zhen Gou, Toronto (CA)

(21) Appl. No.: 17/585,380

(22) Filed: Jan. 26, 2022

Related U.S. Application Data
(60) Provisional application No. 63/142,898, filed on Jan. 28, 2021.

(51) Int. Cl. G06N 3/08; G06N 3/04

(52) U.S. Cl. CPC G06N 3/084; G06N 3/0481

(57) ABSTRACT

A method for training the transformer model that strikes a middle ground between local and global learning by using interlocking backpropagation. Instead of training with one single global objective, or training with each accelerator having its own local objective, the method trains a large-scale network with auxiliary classification layers. The auxiliary classification layers use local losses to optimize a subset of the network. The local losses may be computed based on a group of processing units. Different groups of processing units may contain overlapping processing units such that there is indirect communication flow throughout the network.

### CROSS REFERENCE TO RELATED APPLICATIONS

This application claims priority under 35 U.S.C. § 119(e) to U.S. Provisional Patent Application No. 63/142,898, filed Jan. 28, 2021, which is incorporated by reference.

### BACKGROUND

This disclosure relates generally to training computer-implemented models. More specifically, this disclosure relates to training a transformer model using interlocking backpropagation.

Computer-implemented models, such as modern neural networks, with a large number of parameters are powerful in learning complicated relationships between inputs and outputs. The model uses these parameters to execute a set of functions on the input and generate an output. The model typically applies the functions in the set of functions sequentially, which are typically executed by an accelerator on one or more computer systems. Modern state-of-the-art language models may be trained with colossal datasets with a vast number of parameters to learn contextual relationships between words. However, these models, particularly during training, are often too large to fit in the memory of a single accelerator. As a result, the training computation must be distributed across multiple accelerators, which is accomplished by partitioning the model across several accelerators and communicating the training information between the accelerators. Such a model is termed a distributed model. In other words, a distributed model may be described as a composition of a series of functions that are partitioned into contiguous groups with each group placed on an individual accelerator. Each contiguous group of functions operating on a single accelerator may be referred to as a processing unit.

Information for training the models may be communicated between the accelerators, including information for forward and backward propagation. A forward propagation or forward pass may refer to information flow in a forward direction by calculating a result using the functions processed by the accelerator (e.g., activation functions), which may produce activation values as an output representing either the output of the model or used by subsequent portions of the model. In training, the output of the model is evaluated with an error function (may also termed as a loss function) describing the difference between the model output and the desired output of the model. A backward pass or backward propagation propagates error information through layers of the model so that the parameters of each model is modified to reduce the expected error.

One naïve way to coordinate training of such a distributed model is referred to as “global learning.” With global learning, each accelerator must wait for all downstream accelerators to compute their forward and backward passes before it begins computation of its own backward pass. Training with global learning incurs significant inefficiencies, because each accelerator spends a significant amount of time remaining idle and waiting on results from subsequent accelerators. Moreover, global training requires a significant amount of communication between accelerators, which further introduces time and computation inefficiencies.

Another way to coordinate a training for a distributed model is referred to as “local learning.” In local learning, each accelerator only needs to pass activation values, which are outputs from activation functions, to the next accelerator and does not need to wait for returning gradients. In other words, each accelerator is responsible for using its own training signal to compute and apply parameter updates. Local learning resolves the issue of inefficient idling accelerators, but the efficiency comes at a significant cost to the accuracy of the resulting model. Because of the absence of communication between layers higher in the model and layers lower in the model, local learning suffers from degradation in modelling performance comparing to global learning.

### SUMMARY

Computer-implemented models, such as neural networks, particularly transformers, are trained with increased efficiency while maintaining performance. This training approach permits each processing unit to improve its parameters with respect to losses of a subset of the entire model. This approach, termed “interlocking backpropagation” increases training time efficiency comparable to global learning while improving results achievable with local learning.

Training computer-implemented models with interlocking backpropagation may involve training auxiliary classification layers that use local losses to optimize only a subset of the network. Local losses may be computed based on a subset of processing units. The auxiliary layers may be attached to certain processing units before the end of the network and pass gradients to lower processing units to make local loss information available to lower processing units sooner. In one embodiment, a model may use multiple auxiliary layers, with each auxiliary layer in charge of passing the loss of a subset of processing units backwards. The different subsets of processing units may contain “interlocking” processing units that appear in more than one subset of processing units and therefore enable communication flow throughout the network.

A transformer (also called a transformer model) is a type of computer-implemented model often used for natural language processing. A transformer typically includes some number of “encoder” layers that generate a representation of an input, and a number of “decoder” layers which decode the representation to an output. Transformers are a state-of-the-art natural language processing model that demands a considerable large memory requirement because of the model architecture that benefits from being arranged as a distributed model across multiple accelerators.

Interlocking backpropagation may be particularly applied to transformers because of the unique architecture of the transformers model. Normally, splitting a computer-implemented model is complicated and challenging because it often involves extensive work such as re-implementation of the model so that it is divisible and to provide workload balancing among processing units. However, because of the unique encoder-decoder structure of the transformers model, each processing unit in a transformer model may be partitioned by the boundaries of encoders or decoders, as each encoder or decoder may be viewed as a contiguous group of functions. Training a transformer model using interlocking backpropagation may benefit from the encoder/decoder structure because the transformer model may be divided and distributed among a group of processing units based on boundaries of encoders or decoders. For example, to train a distributed transformers model, each processing unit for training the model may contain one or multiple encoders and/or decoders.

In one embodiment, a transformer model may be trained with 2 processing units in each subset of processing units. Each processing unit may update parameters based on its own error and error information (e.g. losses and gradients) from a subsequent processing unit. For example, the first processing unit may update parameters based on losses evaluated by the output of the first and the second processing units, and the second processing unit may update parameters based on losses from the second and the third processing units. The second processing unit, which appears in both the first subset and the second subset, may be referred to as an interlocking processing unit. Interlocking processing units enable information flow throughout the model because the interlocking processing units update parameters based on error information from subsequent processing units and passes error information to previous processing units. This exemplary approach of training a transformers model, which includes 2 processing units in each subset, may be referred to as a 2-wise interlocking backpropagation. The approach may be generalized to N-wise interlocking backpropagation, where each subset of processing units contains N processing units, with 1 to (N−1) interlocking processing units.

Training the transformers model with interlocking backpropagation is advantageous from three perspectives. From efficiency perspective, because the communication between accelerators may be costly, training with a subset of local losses speeds up the learning process and reduces idling time that the processing units spend waiting to receive error information from subsequent processing units. From a performance perspective, interlocking backpropagation enables information flow throughout the transformers model because the interlocking processing units connect and enable earlier processing units to update parameters based on error information from subsequent processing units before the final processing unit, which significantly improves performance upon local learning and achieves comparable results to global learning.

### BRIEF DESCRIPTION OF THE DRAWINGS

FIG. 1A illustrates an overall structure of an example transformer model, in accordance with one embodiment.

FIG. 1B illustrates an overall structure of a transformer model with only decoders, in accordance with another embodiment.

FIG. 2 is a flow chart that illustrates a detailed structure of a transformer model, in accordance with one embodiment.

FIG. 3 illustrates a transformer model with only decoders, in accordance with one embodiment.

FIG. 4 is a flow chart illustrating a detailed attention module of a transformer model, in accordance with one embodiment.

FIG. 5 is a flow chart illustrating a feedforward module of a transformer model, in accordance with one embodiment.

FIGS. 6A and 6B illustrate two different structures for training a transformer model using interlocking backpropagation according to one embodiment.

FIG. 6C illustrates communication between processing units according to one embodiment.

FIGS. 7A-7D illustrate different embodiments of interlocking backpropagation with various exemplary implementations.

FIGS. 8A-8D illustrate scheduling of forward and backward passes for the different embodiments illustrated in FIGS. 7A-7D.

FIG. 9 illustrates a comparison in time efficiency between various N-wise interlocking backpropagation strategies.

### DETAILED DESCRIPTION

### System Overview

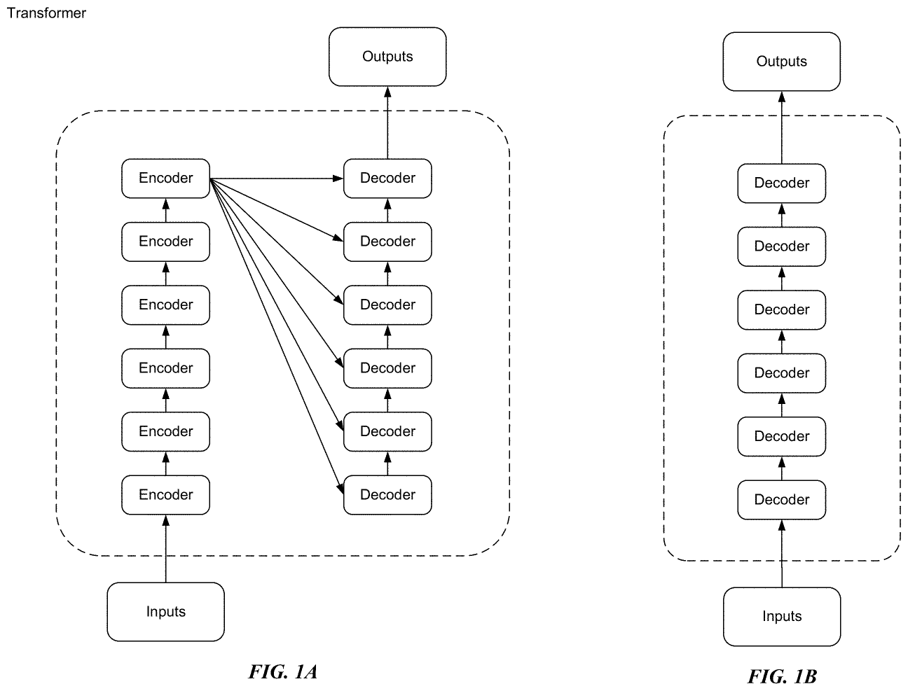

FIG. 1A illustrates a high-level structure of a transformer model, according to one embodiment. A transformer model may be used in various applications, some of the examples include, but not limited to, machine language translations, automatic conversation generator and context summarization. A transformer model takes a sequence of elements as input and produces probabilities associated with a number of pre-defined classes as output. For example, for a translation tool that is built based on a transformer model, the sequence of input elements may be a sentence such as “I love patents” and the output of the model may be “Amo las patentes” which is “I love patents” in Spanish. In another embodiment where an automatic conversation generator is trained by a transformer model, the input may be “I love patents” and the output may be “Awesome, me too.”

As illustrated in FIG. 1A, a transformer model may use an encoder-decoder architecture with an encoding component and a decoding component. An encoder may map an input sequence into an abstract representation describing relationships between the elements in the input sequence. A decoder functions similarly but has a slightly different structure that is discussed below. Each encoder and decoder may include one or more neural network layers, which may be viewed as a contiguous group of functions. The encoding component may consist of multiple encoders stacking on top of each other and, similarly, the decoding component may consist of a stack of multiple decoders. In another embodiment, the Transformers model may only have a decoder component as illustrated in FIG. 1B.

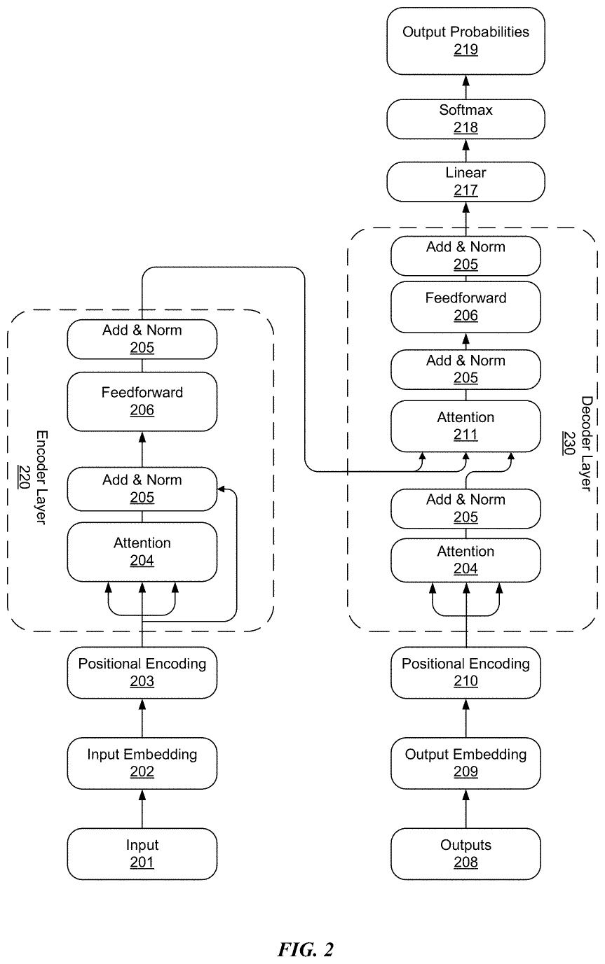

FIG. 2 illustrates an example transformer model according to one embodiment. The input 201 of the transformer model may be a sequence of ordered elements. For example, the input 201 may be a sentence from a document or an ordered set of words. The input 201 may be passed through an input embedding module 202 which generates input embeddings that represent the input 201 as numerical vectors in latent space. Input embedding module 202 compresses information into fixed length vectors instead of having the input represented by a large-scale but sparse vector that is based on the whole English Dictionary which consists more than 100,000 words. Referring back to the previous example, the input 201 may be “I love patents” and each word may be embedded into a numerical vector of length 512. That is each word is mapped into a space of dimension 512 and is represented by a vector with 512 numerical values. As a result, the sentence “I love patents” is mapped into a matrix with three vectors of length 512. The positional encoding module 203 receives the inputs and generates positional information to be associated with the input embeddings, so that each individual element has an associated representation and positional information. Because the input 201 is an ordered list of elements, each element has its respective positional information describing its position in the ordered list. The positional encoding module 203 encodes this information in the input embedding vectors and outputs input embedding vectors with positional information encoded. For example, suppose input is a sentence with five words and each word is embedded into a vector of length 512. As a result, the output from the input embedding module 202 is a 5 by 512 matrix, with each word represented by a vector of length 512 with continuous numerical values. The positional encoding module 203 may further add one or more positional encoding values to each vector. The output from positional encoding 203 may be subsequently passed through an encoder component and a decoder component. Because each encoder of the stack of encoders share identical structure, the encoder layer 220 in FIG. 2 illustrates an example of one of potentially multiple encoders. Similarly, the decoder layer 230 in FIG. 2 also illustrates one example of many decoders.

The size of the outputs from positional encoding module 203 may vary based on the number of the input 201, and the variable-sized vectors outputted from positional encoding module 203 may be subsequently passed through an encoder component and a decoder component. Because each encoder of the stack of encoders share identical structure, the encoder layer 220 in FIG. 2 illustrates an example of one of potentially multiple encoders. Similarly, the decoder layer 230 in FIG. 2 also illustrates one example of many decoders.

Encoders and decoders in some embodiments share a similar structure. Two of the core modules for encoders and decoders are attention module 204 and feedforward module 206. On a high level, the attention module 204 associates each individual word in the input to other words in the input. The attention module 204 may take input embeddings as input and may produce numerical vectors representing learned relational information describing how each word is associated with other words in the input. The feedforward module 205 contains a fully connected feedforward network, which is applied to each input element separately and identically. Details with regard to the attention module and the feedforward module are discussed below.

Each attention module 204 and feedforward module 206 are followed by an add & norm module 205. The add & norm module 205 is a residual connection and layer normalization module, which adds the output from attention module 204 to the input of the attention module 204 and conducts a layer normalization of the sum. The add & norm module 205 may help stabilize the hidden state dynamics in networks and may reduce training time.

Referring to FIG. 2, decoder layer 230 may also contain a self-attention module 204, a second attention module 211, and a feedforward module 206 followed by add & norm module 205. In one embodiment, a decoder layer 230 receives outputs 208 as part of its input. For example, if the task is to translate “I love patents” to “Amo las patentes,” input 201 is “I love patents” while outputs 208 is “Amo las patentes.” The encoder layer 220 learns information regarding how each English word associates with each other while the attention module 204 in the decoder layer 230 learns how each Spanish word associates with each other. Then the second attention module 211 learns how each English word associates with each Spanish word.

The structure of a decoder layer 230 is different from the structure of an encoder layer 220 in that the decoder layer 230 has a second attention module 211 which takes part of the outputs from the encoder layer 220 as input. Another difference between the encoder layer 220 and the decoder layer 230 is the attention module 204. In training the attention module 204, the decoder layer 230 may apply a look-ahead mask to score matrices to make sure each element in the sequence only has access to elements that are in front of it in the sequence and does not have information flow backwards. This is to preserve the auto-regressive property of the decoder layers.

The decoder layer 230 produces vectors with continuous numerical values as output. That is, the output from the decoder layer 230 contains information describing how each element of the input 201 and the output 208 associate with each other and how each element of the output 208 associate with other elements in the output 208. The output from the decoder layer 230 may be further passed through a linear layer 217 for final processing such as a transformation in dimension of the decoder outputs so that the outputs are ready to be passed to the subsequent softmax layer 218. The softmax layer 218 produces probability scores between 0 and 1 that indicate a likelihood of the next element in the ordered list being classified as one of many of pre-defined classes. For example, the number of pre-defined classes may be 10,000, and each class represents a possible word in a corpus. The output probabilities 219 may be a vector of length 10,000, associating each of the pre-defined classes with a probability score. The output probabilities 219 may determine that a certain class (in this example, a certain word) has the highest probability of being the next word in the sentence.

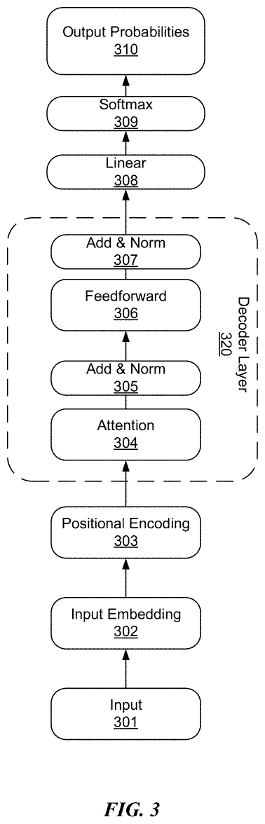

In yet another embodiment, the transformer model may contain only a stack of decoders, as illustrated in FIG. 1B. Details with regard to this architecture are discussed below and illustrated in FIG. 3.

FIG. 3 illustrates an example decoder structure of a transformer model with only decoders. In this embodiment, the decoder 320 only consists one masked attention module 304 and a feed forward module 306. The masked attention module 304 is similar to the attention module 204 in FIG. 2, where the masked attention module 304 masks future outputs therefore blocking information from the sequenced outputs that are after the position being calculated. The system feeds inputs 301 to an input embedding module 302, where inputs 301 are embedded into input embeddings. The input embeddings are further encoded with positional information through the positional encoding module 303. Output from the positional encoding module 303 are fed into a decoding component consisting of decoder layers 320. The decoder layer 320 contains two core modules, an attention module 304 and a feedforward module 306.

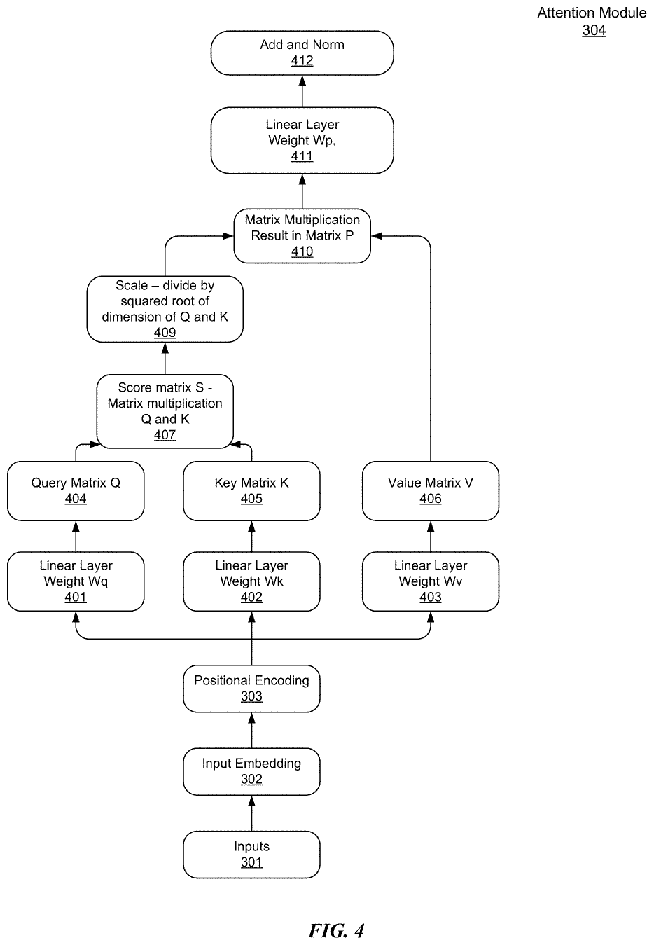

Referring to FIG. 4, the attention module 304 takes output from the positional encoding module 303 as input and trains the model with three distinct linear layers 401-403. The linear layers 401-403 are trained to generate a query matrix, a key matrix and a value matrix. On a high level, the concept of the query, key and value matrices is analogous to a retrieval system, where the query matrix represents what kind of information is needed, and the key and value matrices represent a set of key-value pairs that contain the actual content. The query, key and value matrices are trained by linear transformation layers through different weight matrices. If the input 201 contains N elements, then the trained query, key and value matrices may also contain N vectors where each vector is mapped to a latent vector space represented by continuous numerical values. In other words, each element in the input 201 is mapped to a set of query, key and value vectors. The linear layer 401 is associated with a weight matrix Wq, the linear layer 402 is associated with a weight matrix Wk and the linear layer 403 is associated with a weight matrix Wv.

Continuing with FIG. 4, multiplication 407 of the query matrix 404 and the key matrix 405 results in a score matrix 407 which may be a n-by-n matrix, where n is the number of elements in the inputs 301. The score matrix S may represent how much focus each element should put on every other element in the inputs 301. Each element may have a score with respect to every other element, and the higher the score, the more the focus. The score matrix S may be scaled 409 by a temperature value, which is the squared root of the dimension of the key matrix 405 and the query matrix 404. That is, S is divided by \sqrt{dₖ} where dₖ is the dimension of the key matrix 405 and the query matrix 404. The scaling step 409 may allow for more stable gradients, since multiplying large-scale matrices may have an exploding effect because for large values of dₖ, the dot product of two large-scale vectors may grow large in magnitude, which may push softmax functions into regions where gradients are extremely small resulting in a stagnating learning process. Therefore, scaling the score matrix S with a scaling factor of

$$\frac{1}{\sqrt{{d}_{k}}}$$

may counteract this effect.

The scaled score matrix outputted from the scaling step 409 is multiplied 410 by the value matrix 406, resulting in an output matrix P. The output matrix P passes through another linear layer 411 for processing. Output from the linear layer 411 goes through one more add & norm layer 412 and finally reaches the feedforward module 306.

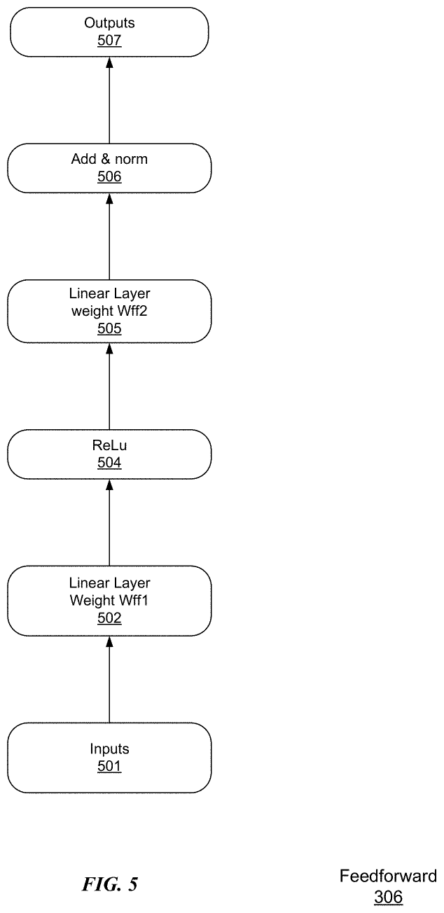

The feedforward module 306 is illustrated in detail in FIG. 5. The feedforward module 306 contains two linear layers 502 and 505 with a ReLU activation 504 in between. Outputs from the attention module 304 are fed as inputs 501 into the feedforward module 306. Inputs 501 first go through a linear layer 502 which is associated with a weight matrix W_{ff1}. Outputs from the linear layer 502 further pass through a ReLU layer 504 for better performance. Then, results from the ReLU layer may then go through another linear layer 505 with a weight matrix W_{ff2}. Outputs from the second linear layer 505 pass through a final add & norm layer 506 and outputs 507 are produced, which concludes the decoder layer 320.

Now referring back to FIG. 2, the output from the decoder layer 230 may further pass through a linear layer 217 for final processing. Output from the final linear layer 217 goes through a softmax layer 218. The softmax layer 218 produces probability scores between 0 and 1. The probability scores indicate a likelihood of the next element in the ordered list being classified as one of many of pre-defined classes. For example, the number of pre-defined classes may be 10,000, and each class represent a possible word in a corpus. The output probabilities 219 may be a vector of length 10,000, associating each of the pre-defined classes with a probability score. The output probabilities 219 may determine that a certain class, or in this case, a certain word has the highest probability of being the next word in the sentence.

### Training Transformers Using Interlocking Backpropagation

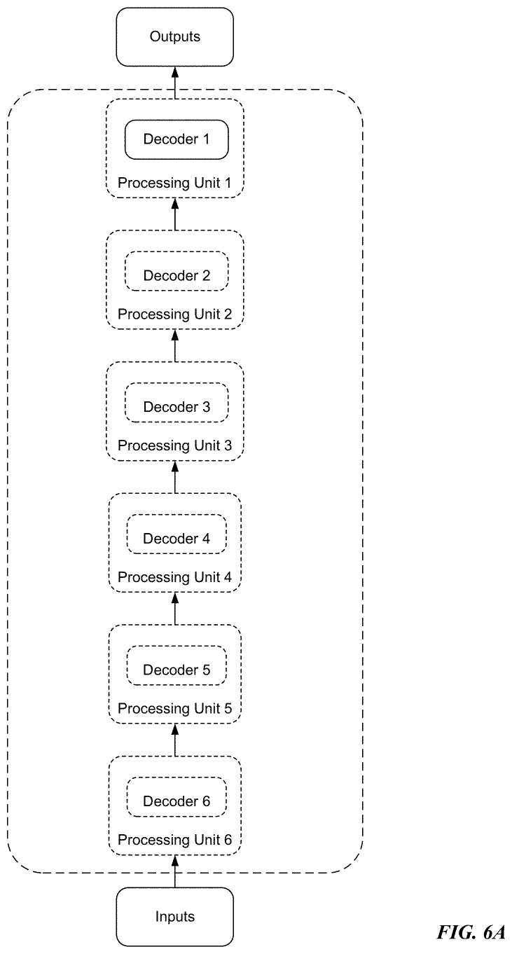

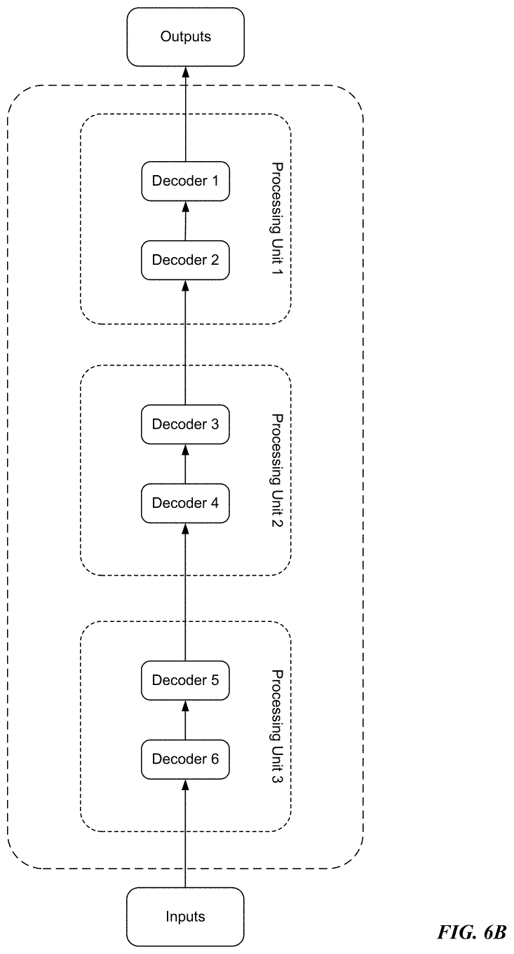

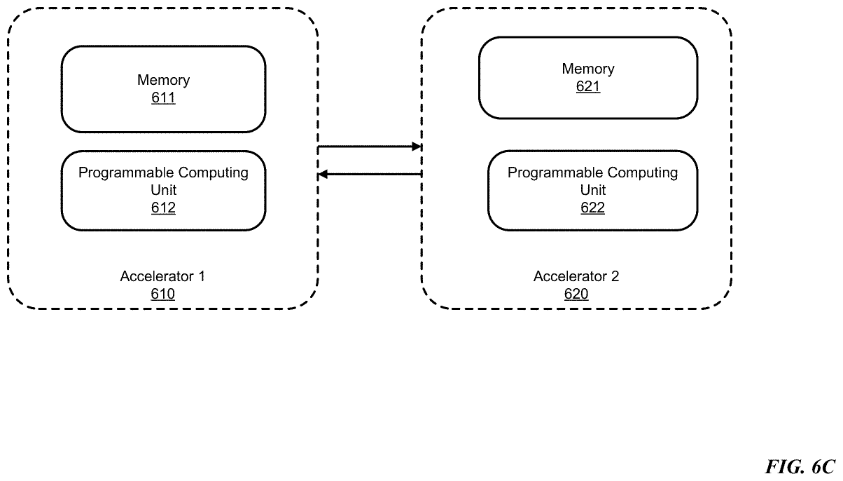

A distributed model may be described as a composition of a series of functions. When the size of the model exceeds the limit of a processing unit, contiguous groups of these functions can be placed on individual processing units. As illustrated in FIG. 6A, each processing unit may be a hardware accelerator or computer system created to accelerate neural network tasks. Some examples of processing units are Computing Processing Unit (CPU), Graphics Processing Unit (GPU), Vision Processing Unit (VPU), Field-Programmable Gate Array (FPGA), Application Specific Integrated Circuit (ASIC) and Tensor Processing Unit (TPU). Model functions often include matrix or tensor processing that may benefit from specialized hardware optimized for processing such structures.

It is often costly to distribute network layers among multiple processing units because the distribution process often involves deciding where to split the model, re-implementing the model so that it is divisible and balancing workload among processing units. However, the unique encoder-decoder structure of transformers makes the splitting process more efficient. Because each encoder/decoder may be viewed as a structure that contains a contiguous group of functions, boundaries of the groups of contiguous functions placed on one processing unit may be determined by the boundaries of encoders/decoders. For example, FIGS. 6A and 6B illustrate two ways to divide the network layers of a transformers model among multiple processing units. In FIG. 6A, each processing unit contains one decoder while in FIG. 6B each processing unit contains two decoders. In other embodiments, the number of encoders or decoders placed on a processing unit may be adjusted as long as the size of the total encoders and decoders placed on the processing unit does not exceed the memory of the processing unit.

FIG. 6C illustrates a structure of processing units and how processing units communicate. Each processing unit may operate on an accelerator, such as accelerator 610, which may include a programmable computing unit 612 and a memory 611. The programmable computing unit 612, which may include multiple processors each with multiple cores, processes instructions and performs computations. A multi-core multi-processor structure makes the programmable computing unit 612 highly efficient in parallel computing and processing. Memory 611 stores information associated with the contiguous group of functions of a processing unit. Memory 611 may include a shared memory that may be shared among the multiple processors. Memory 611 may also include shared cache memory among processers, and each processor may further have its own memory such as registers. Processing units may communicate through a bus or network. Alternatively, processing units may communicate through a global memory that is accessible to all processing units. Communication between processing units involves data transferring and data synchronization, which consumes time and memory resources and may potentially cause decreases in efficiency.

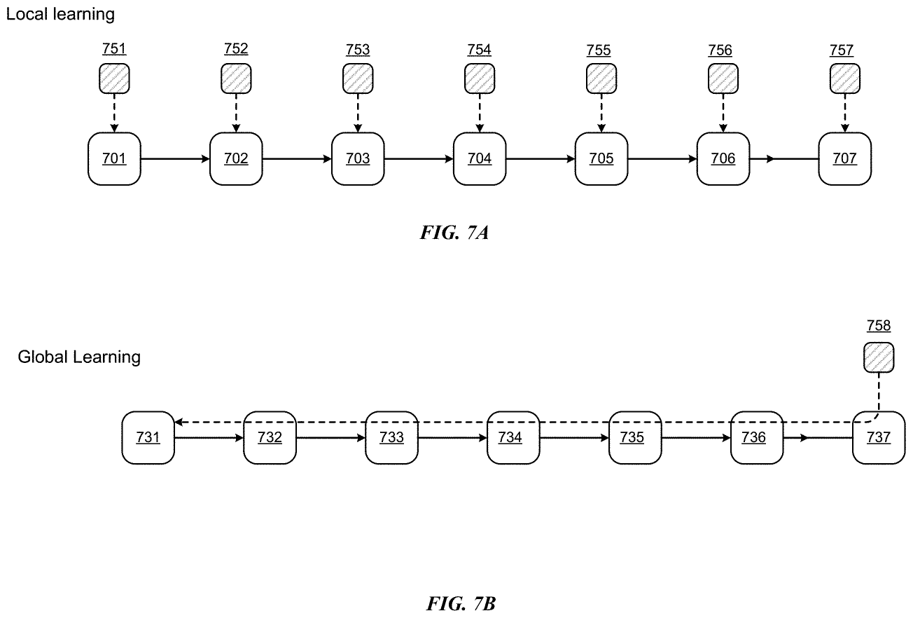

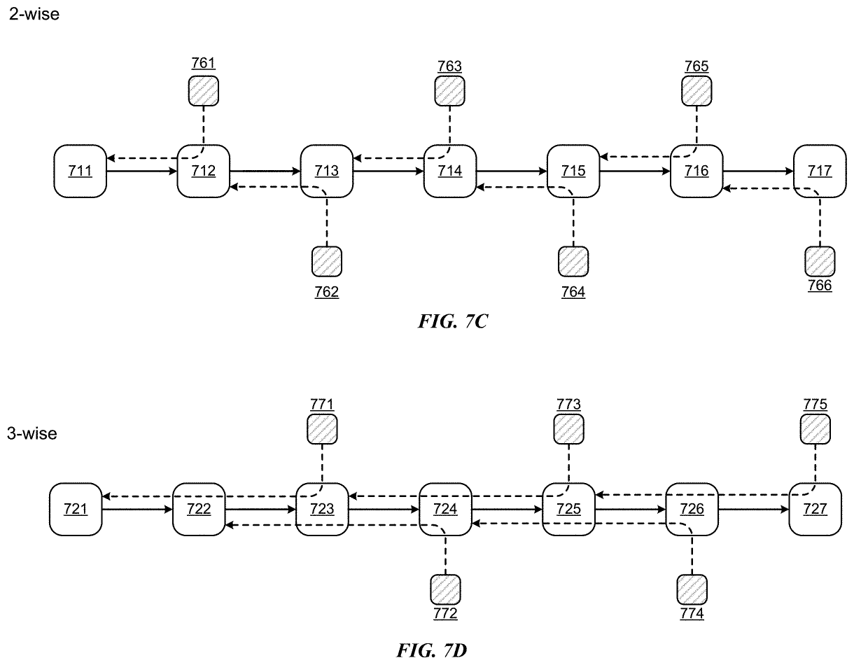

FIGS. 7A-7D illustrate flow of activations and error information for training a distributed model in various embodiments. Forward passes are shown in black arrowed lines and backward passes are shown in dotted lines. A forward pass may refer to the process that a network layer computes activation values based on input and parameters and pass the activation values to the next layer. A backward pass may refer to the process that a network layer computes error (may also termed as loss) based on parameters and passes the error information backwards to a previous layer. In some embodiments, a backward pass is followed by updating parameters associated with the layer based on the error information, while in other embodiments a network layer may pass error information backwards without updating parameters.

FIG. 7A illustrates information flow through local learning. Each processing unit 701-707 passes activation results to the next processing unit and updates parameters only based on its own loss. For example, processing unit 701 may pass activation values to processing unit 702. Processing unit 701 does not wait on any results from subsequent processing units. Instead, processing unit 701 updates parameters based on its own loss. Similarly, each auxiliary classification layer 751-757 may calculate gradients directly from each single processing unit 701-707 and each processing unit may immediately update its parameters using its own gradients (which are calculated based on losses). As illustrated in FIG. 7A, the only communication among processing units is the flow of activation values in forward passes. As a result, limited communication between processing units and training based on local losses degrade model performance.

FIG. 7B depicts end-to-end training for a distributed model, or global learning as mentioned previously. In this embodiment, each processing unit 731-736 forward propagates activation values to the next processing unit and waits for gradients to be passed back. For example, processing unit 731 forward propagates activation values to processing unit 732, processing unit 732 forward propagates activation values to processing unit 733, and the subsequent processing units 734-737 may perform the same. The last processing unit such as processing unit 737 may compute loss based on its parameters, compute gradients and update parameters. The processing unit 737 may then backpropagates gradients to processing unit 736 through the auxiliary classification layer 758 and processing unit 736 may update its own parameters based on the backpropagated gradients. Processing units 736 through 731 may perform the same updates. During this process, processing unit 731 is idle until the gradients are backpropagated from the last processing unit 737 through processing units 736-732. Similarly, processing unit 732 may also remain idle while waiting for backward error information from subsequent processing units. Therefore, global learning introduces longer idling time for processing units, while they wait for error information being backpropagated. However, because each processing unit updates its parameters using loss information from all the processing units, the model is able to achieve a more desirable performance.

Training a distributed model that updates parameters by optimizing losses from subsets of processing units with overlapping processing unites between different subsets of processing units, as illustrated in FIGS. 7C and 7D, provides a certain level of communication between processing units which improves performance while being time efficient. FIG. 7C depicts information flow among processing units, according to one embodiment. This strategy may be referred to as 2-wise interlocking backpropagation, because each processing unit optimizes losses from two processing units, i.e. both its own loss and the loss from a subsequent processing unit. For example, a first processing unit 711 passes activation values to a second processing unit 712. The auxiliary layer 761 uses the activations of processing unit 712 to directly output prediction based on the parameters of the attached processing unit. The predicted output by the auxiliary layer 761 is used to determine an error with respect to the output of processing unit 712. The error with respect to processing unit 712 is backpropagated to processing unit 711 for processing unit 711 to train the parameters of the functions processed by processing unit 711. Similarly, processing unit 712 forward propagates activations to a third processing unit 713. Auxiliary network layer 762 computes losses and backpropagates the gradients to processing unit 712. Then processing unit 712 may update parameters based on its own loss and gradients passed back from processing unit 713 based on a loss from auxiliary layer 762. As a result, the second processing unit 712 acts as an interlocking processing unit that connects the first and the third processing units and enables information flow between the first processing unit 711 and the third processing unit 713.

As a result of the information flow throughout the entire model because of the interlocking processing units, a transformer model trained with interlocking backpropagation may only use the output of the last processing unit to make predictions. For example, for a model trained with the embodiment illustrated in FIG. 7C, while each processing unit 711-717 has a set of parameters used to make an intermediate predictions with auxiliary layers, the final prediction is based on the full sequence of processing units by making predictions using the output of the last processing unit 717. The output from the last processing unit thus benefits from all information learned by each processing unit.

In another embodiment, FIG. 7D depicts information flow in 3-wise interlocking backpropagation, where each processing unit optimizes losses from three processing units. For example, processing unit 721 passes activations to processing unit 722, which applies its own calculations and passes activations to processing unit 723. Auxiliary classification layer 771 makes predictions using parameters from processing unit 723 and computes error information based on the predictions. Auxiliary classification layer backpropagates the error information to processing unit 722 and further back propagates error information associated with processing unit 722 to processing unit 723. Then, processing unit 721 updates parameters based on the backpropagated error information from processing units 721, 722 and 723. Similarly, processing unit 722 updates its parameters based on its own error and the error information passed back by processing units 723 and 724. Comparing to 2-wise interlocking backpropagation, 3-wise training may achieve a more desirable model performance because updates in gradients are computed based on information passed from three processing units instead of two. The trade-off, at the same time, is that the idling time for each processing unit may increase. For example, processing unit 721 remains idling whiling waiting for loss information propagating back from processing units 722 and 723, whereas in 2-wise interlocking propagation, processing unit 711 only needs to wait for loss propagating back from processing unit 712.

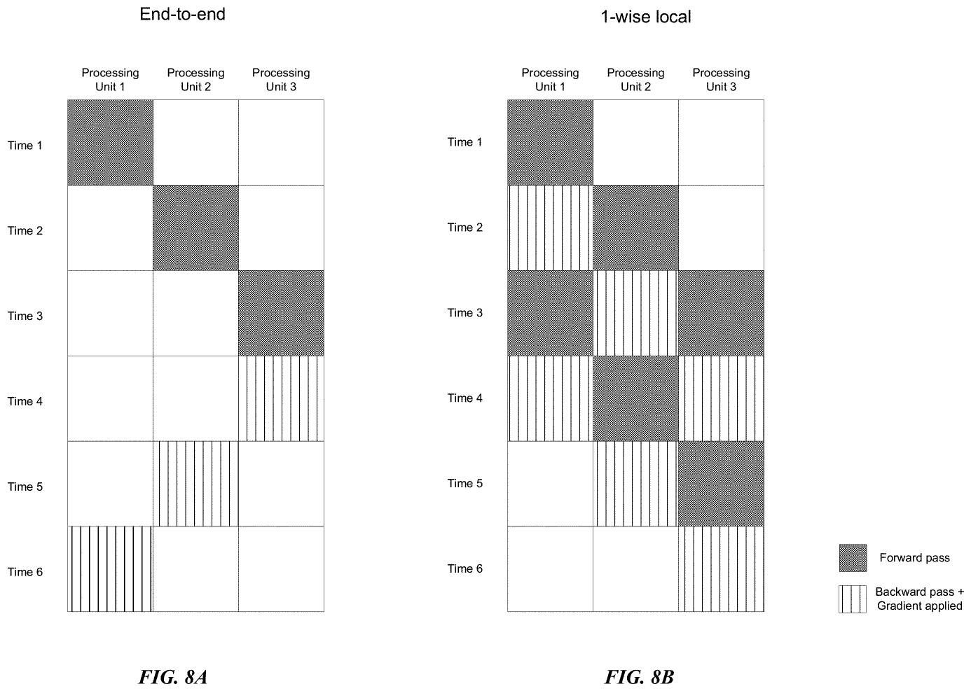

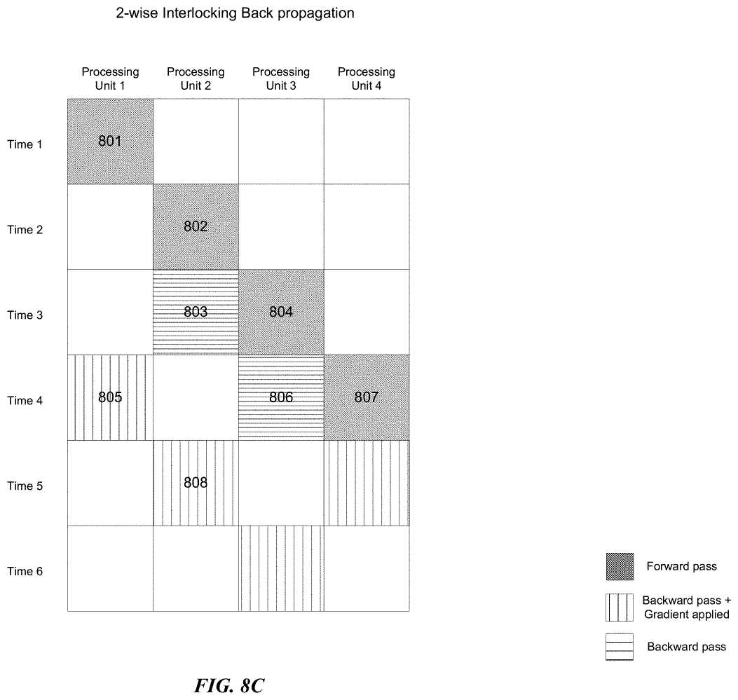

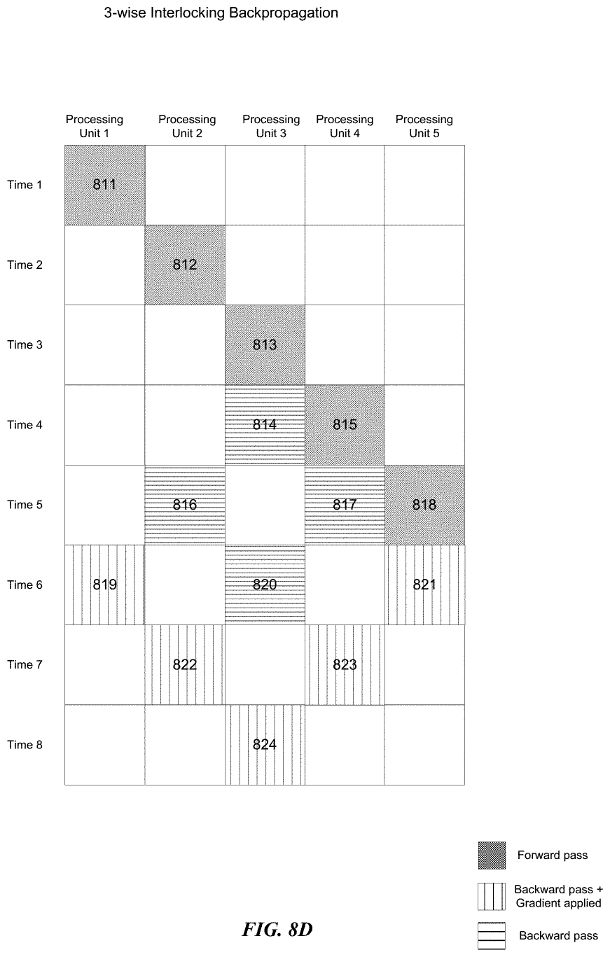

FIGS. 8A-8D illustrate working schedules for processing units in the different embodiments illustrated in FIGS. 7A-7D. FIGS. 8A and 8B illustrate global learning and local learning, respectively. FIGS. 8C and 8D illustrate 2-wise and 3-wise interlocking propagation, respectively.

FIG. 8 illustrates a working schedule for processing units in a global learning process. Each shaded box indicates a forward pass, each box with vertical stripes indicates a backward pass with gradient updates, and each blank box indicates that the processing unit is idling. At time 1, processing unit 1 forward propagates activations to processing unit 2. Similarly, at time 2 and 3, activations flow through processing unit 2 and processing unit 3. At time 4, processing unit 3 calculates loss and gradients, applies updates to parameters and backpropagates gradients to processing unit 2. At time 5, processing unit 2 updates parameters and backpropagates gradients to processing unit 1. Finally, processing unit 1 updates parameters based on the backpropagated gradients. Notice that in global learning strategy, processing unit 1 stays idle from time 2 to time 5 (as illustrated by the blank boxes from time 2 to time 5 for processing unit 1), waiting on the gradients from the backward pass. Similarly, processing unit 2 also stays idle from time 3 to time 4. The example illustrated in FIG. 8A only shows three processing units. In other embodiments where more processing units participate in the training process, processing units may experience longer idling time. The long idling time decreases model efficiency and diminishes resource utilization.

FIG. 8B illustrates local learning. At time 1, processing unit 1 passes activation values to processing unit 2. At time 2, processing unit 1 directly updates its own parameters based on its local loss. At the same time, time 2, processing unit 2 propagates activations to the next processing unit, processing unit 2. Processing unit 1 does not need to wait on any results from subsequent processing units and therefore is continuously at work. Similarly, for other processing units, the idling time is significantly decreased which makes local learning more efficient. However, because the only communication between the processing units is propagating the activations during the forward pass, without backwards communication between processing units, local learning fails to match the global learning accuracy.

FIGS. 8C and 8D illustrate work schedule for processing units using interlocking backpropagation. These embodiments improve the efficiency upon global learning while reaching comparable results because the “interlocking” processing units act as an intermediary that enables information flow through the model.

For example, referring to FIG. 8C, at time 801 and time 802, processing unit 1 and processing unit 2 forward propagates activations. At time 803, auxiliary classification layer, that is associated with processing unit 1 and 2, calculates losses and gradients and backpropagates error information to processing unit 1. Notice that processing unit 2 at time 803 is illustrated by a box with horizontal stripes, which indicates passing error information back to processing unit 1 without updating parameters of processing unit 2. This is because processing unit 2 does not update its parameters until it receives gradients from processing unit 3 at time 805. Each processing unit updates parameters based on losses from 2 processing units (i.e. loss from a subsequent processing unit and loss from itself). At time 805, processing unit 1 receives the backpropagated error information and updates parameters. The first processing unit updates its parameters using losses from both processing unit 2 and its own loss. Similarly, processing unit 2 does not update its parameters until time 808, when it receives the gradients backpropagated from processing unit 3. That is, in 2-wise interlocking backpropagation, the kth processing unit optimizes parameters based on the losses from itself (i.e. the kth processing unit) and the loss from the (k+1)th processing unit.

In another embodiment, FIG. 8D illustrates 3-wise interlocking backpropagation. Time 811 to time 813 are forward passes. At time 814, an auxiliary classification layer, that is associated with processing units 1-3, calculates losses and backpropagates error information from processing unit 3 at time 814 and further backpropagates error information to processing unit 1 at time 816. At time 819, processing unit 1 updates its parameters based on losses from the first three processing units, which are received from the auxiliary layer. Notice that, similar to 2-wise training, during time 814 and time 816, processing units 3 and 2 do not update their parameters. Processing unit 2 does not update gradients until time 822 when the losses from its two subsequent processing units (i.e. processing unit 3 and 4) are passed back through 817 and 820. To summarize the strategy for 3-wise interlocking backpropagation, each processing unit optimizes the losses from itself, the (k+1)th and the (k+2)th processing units. If the processing unit is the last one in the model, such as processing unit 5 at time 818 in FIG. 8D, the processing unit may immediately update its gradients such as illustrated at time 821 and backpropagates error information to the previous processing unit. For example, processing unit 5 at time 818 finishes computing activations. At time 821, an auxiliary classification layer computes gradients and applies updates to parameters and backpropagates gradients to processing unit 4 at time 823.

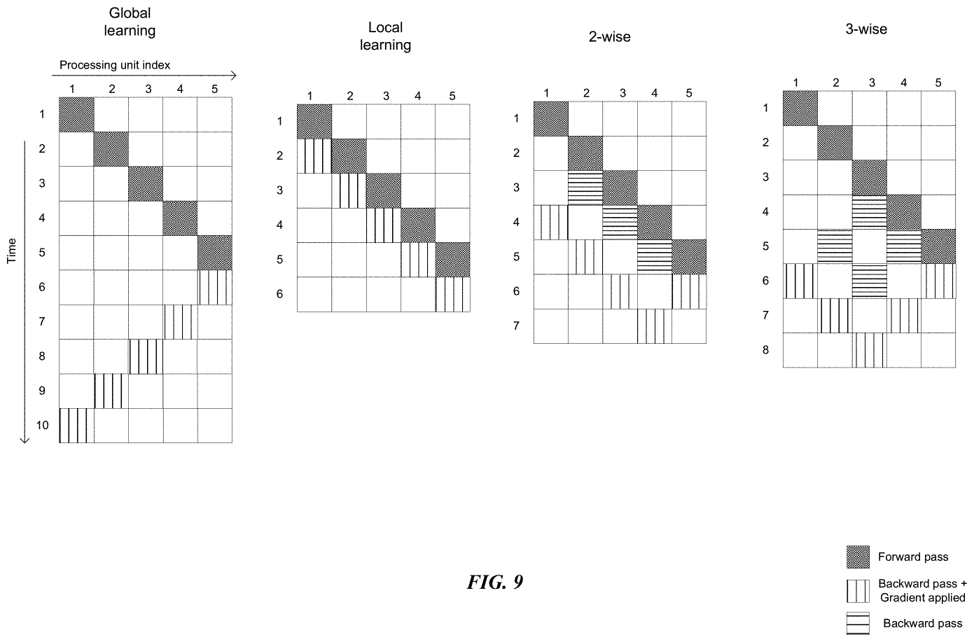

Comparing to global training illustrated in FIG. 8A, interlocking backpropagation training as illustrated in FIGS. 8C-D is more time efficient. FIG. 9 demonstrates a comparison between time complexity among the 4 different strategies. Each figure in FIG. 9 illustrates the time complexity for running one complete forward pass and backward pass through all processing units (e.g. five processing units as illustrated in FIG. 9). From the comparison, global learning takes the most amount of time (10 time units as illustrated in FIG. 9) to finish a complete forward pass and a complete backward pass while local learning may finish the job with less time (6 time units). 2-wise and 3-wise interlocking backpropagation both improve time efficiency upon global learning and completes in 7 and 8 time units, respectively. At the same time, interlocking propagation may achieve comparable performance to global learning with the task finished in less time.

Although only 2-wise and 3-wise interlocking backpropagation are illustrated in detail, the training may be further generalized to N-wise interlocking backpropagation, that is, each processing unit may update its parameters based on a varying number of subsequent processing units. For example, suppose there are M processing units in total and the model is trained with N-wise interlocking backpropagation. The kth processing unit updates its parameters using error information from the (k+N−1)th processing unit, which have been propagated backwards through the intermediate processing units. When N is set to 1, it is equivalent to local learning, and when N is set to the total number of processing unit M, this is equivalent to global learning.

Various N-wise interlocking backpropagation strategies are connected through a trade-off between time efficiency and performance. As N gets bigger and a given processing unit learns from information further forward in the network, the model may achieve better performance, but the performance comes with a cost of time efficiency. Interlocking propagation improves time efficiency upon global learning while maintaining performance by striking a middle ground between local learning and global learning.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for training a transformer model comprising:
receiving input data, the input data containing a sequence of elements;
initializing the transformer model that comprises a plurality of neural network layers; and
training the transformer model with a plurality of processing units, wherein the plurality of processing units is sequentially arranged, and each processing unit contains at least one layer of the plurality of neural network layers, the training comprising:
determining a boundary number, wherein the boundary number determines the number of processing units that each processing unit's gradient updates is based on; and
for each processing unit:
repeatedly forward propagating one or more values calculated based on a set of parameters and based on one or more activation functions;
repeatedly backpropagating one or more error terms obtained from one or more loss functions;
updating the set of parameters of the transformer model based on the error terms backpropagated from a set of subsequent processing units, the set of subsequent processing units is determined based on the boundary number; and
stopping the backpropagation after a predetermined number of updates.

2. The method of claim 1, further comprising:
storing the parameters from a processing unit of the plurality of processing units; and
making predictions using the stored parameters.

3. The method of claim 1, further comprising:
a first processing unit that is associated with a first set of subsequent processing units;
a second processing unit that is associated with a second set of subsequent processing units, the second processing unit following the first processing unit; and
the first set and the second set of subsequent processing units comprising common processing units.

4. The method of claim 1, wherein length of idling time for each processing unit is associated with the boundary number.

5. The method of claim 1, wherein the transformer model contains one or more decoders, the one or more decoders each containing a plurality of neural network layers.

6. The method of claim 1, wherein the processing unit comprises one or more decoders.

7. The method of claim 1 wherein an auxiliary network layer is generated to backpropagate losses to preceding processing units.

8. A non-transitory computer-readable storage medium storing executable computer instructions that, when executed by one or more processors, cause the one or more processors to perform operations, the instructions comprising instructions to:
receive input data, the input data containing a sequence of elements;
initialize the transformer model that comprises a plurality of neural network layers; and
train the transformer model with a plurality of processing units, wherein the plurality of processing units is sequentially arranged, and each processing unit contains at least one layer of the plurality of neural network layers, the training comprising:
determining a boundary number, wherein the boundary number determines the number of processing units that each processing unit's gradient updates is based on; and
for each processing unit:
repeatedly forward propagating one or more values calculated based on a set of parameters and based on one or more activation functions;
repeatedly backpropagating one or more error terms obtained from one or more loss functions;
updating the set of parameters of the transformer model based on the error terms backpropagated from a set of subsequent processing units, the set of subsequent processing units is determined based on the boundary number; and
stopping the backpropagation after a predetermined number of updates.

9. The non-transitory computer-readable storage medium of claim 8, wherein the instructions further comprise instructions to:
store the parameters from a processing unit of the plurality of processing units; and
make predictions using the stored parameters.

10. The non-transitory computer-readable storage medium of claim 8, wherein the plurality of processing units comprises:
a first processing unit that is associated with a first set of subsequent processing units;
a second processing unit that is associated with a second set of subsequent processing units, the second processing unit following the first processing unit, wherein the first set and the second set of subsequent processing units comprise common processing units.

11. The non-transitory computer-readable storage medium of claim 8, wherein length of idling time for each processing unit is associated with the boundary number.

12. The non-transitory computer-readable storage medium of claim 8, wherein the transformer model contains one or more decoders, the one or more decoders each containing a plurality of neural network layers.

13. The non-transitory computer-readable storage medium of claim 8, wherein the processing unit comprises one or more decoders.

14. The non-transitory computer-readable storage medium of claim 8, wherein an auxiliary network layer is generated to backpropagate losses to preceding processing units.

15. A computing system comprising:
a processor; and
a non-transitory computer-readable storage medium storing instructions, the instructions when executed by the processor cause the processor to perform steps including:
receiving input data, the input data containing a sequence of elements;
initializing the transformer model that comprises a plurality of neural network layers; and
training the transformer model with a plurality of processing units, wherein the plurality of processing units is sequentially arranged, and each processing unit contains at least one layer of the plurality of neural network layers, the training comprising:
determining a boundary number, wherein the boundary number determines the number of processing units that each processing unit's gradient updates is based on; and
for each processing unit:
repeatedly forward propagating one or more values calculated based on a set of parameters and based on one or more activation functions;
repeatedly backpropagating one or more error terms obtained from one or more loss functions;
updating the set of parameters of the transformer model based on the error terms backpropagated from a set of subsequent processing units, the set of subsequent processing units is determined based on the boundary number; and
stopping the backpropagation after a predetermined number of updates.

16. The computing system of claim 15, wherein the steps further comprise:
storing the parameters from a processing unit of the plurality of processing units; and
making predictions using the stored parameters.

17. The computing system of claim 15, wherein the plurality of processing units comprises:
a first processing unit that is associated with a first set of subsequent processing units;
a second processing unit that is associated with a second set of subsequent processing units, the second processing unit following the first processing unit, wherein the first set and the second set of subsequent processing units comprise common processing units.

18. The computing system of claim 15, wherein length of idling time for each processing unit is associated with the boundary number.

19. The computing system of claim 15, wherein the transformer model contains one or more decoders, the one or more decoders each containing a plurality of neural network layers.

20. The computing system of claim 15, wherein the processing unit comprises one or more decoders.
